(19) United States
(12) Patent Application Publication
(10) Pub. No.: US 2008/0016530 A1
(43) Pub. Date: Jan. 17, 2008

(54) DIGITAL TELEVISION SYSTEM AND RELATED ELECTRONIC PROGRAM GUIDE BROWSING METHOD

(76) Inventor: Yu-Ying Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/775,220

(22) Filed: Jul. 9, 2007

(30) Foreign Application Priority Data
Jul. 11, 2006 (TW) 095125245

(51) Int. Cl. G06F 3/00

(52) U.S. Cl. 725/40

(57) ABSTRACT

Disclosed is a digital television system, which comprises: a receiving module, for receiving a television signal; a parser, coupled to the receiving module, for extracting EPG (ELECTRONIC PROGRAM GUIDE) data of the television signal; a storing device, coupled to the parser, for storing the EPG data; a control signal receiving interface, for receiving a control signal from a remote control device; a processor, coupled to the storing device and the control signal receiving interface, for accessing at least a part of the EPG data according to the control signal; a display; a blender, coupled to the processor and the display, for displaying the EPG data outputted from the processor on the display; wherein the control signal comprises a channel number information.

### BACKGROUND OF THE INVENTION

1. Field of the Invention

The present invention relates to a digital television system and an EPG (ELECTRONIC PROGRAM GUIDE) browsing method, and particularly relates to a digital television system for marking or displaying related information via inputting a specific channel and an EPG browsing method.

2. Description of the Prior Art

Conventionally, a digital television program provider can utilize a digital television signal DTVS to provide an EPG (electronic program guide), which can be displayed in one of the following arrangement types: channel arrangement, timing arrangement, and program arrangement. By using the direction buttons of a control apparatus such as a remote control device, a user can control a digital television for displaying the EPG in an order according to the EPG arrangement type. Such a displaying method can only display the EPG in a predetermined order, however, but cannot show an out of sequence specific channel of the EPG directly indicated by the user. Since digital television is more and more popular and the number of channels has correspondingly increased, such a kind of browsing method is inconvenient.

### SUMMARY OF THE INVENTION

Therefore, one objective of the present invention is to provide a digital television system and an EPG browsing method, which displays the EPG data corresponding to a specific channel on a display according to a control signal indicating the specific channel.

One embodiment of the present invention discloses a digital television system, which comprises: a receiving module, for receiving a television signal; a parser, coupled to the receiving module, for extracting EPG (ELECTRONIC PROGRAM GUIDE) data of the television signal; a storing device, coupled to the parser, for storing the EPG data; a control signal receiving interface, for receiving a control signal from a remote control device; a processor, coupled to the storing device and the control signal receiving interface, for accessing at least a part of the EPG data according to the control signal; a display; a blender, coupled to the processor and the display, for displaying the EPG data outputted from the processor on the display; wherein the control signal comprises a channel number information.

Another embodiment of the present invention discloses a digital television system, which comprises: a receiving module for receiving a television signal; a parser, coupled to the receiving module, for extracting EPG (ELECTRONIC PROGRAM GUIDE) data of the digital television signal; a storing device, coupled to the parser, for storing the EPG data; a control signal receiving interface for receiving a control signal from a remote control device, the control signal indicating a channel number; a processor, coupled to the storing device and the control signal receiving interface, for reading the EPG data according to the control signal and highlighting the EPG data corresponding to the channel number; and a blender, coupled to the processor and the display, for receiving the EPG data outputted from the processor and displaying it on the display.

Another objective of the present invention is to provide a digital television system and an EPG browsing method, which utilizes a specific mark to mark the EPG data corresponding to a specific channel on a display according to a control signal indicating the specific channel.

According to the above-mentioned system and method, a user can get desired program data from the EPG rapidly and effectively and does not need to browse the EPG step by step.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a digital television system according to a preferred embodiment of the present invention.

FIG. 2 is a schematic diagram illustrating a method for browsing an EPG according to a first preferred embodiment of the present invention.

FIG. 3 is a schematic diagram illustrating a method for browsing the EPG according to the first preferred embodiment of the present invention.

FIG. 4 is a schematic diagram illustrating a method for browsing an EPG according to the first preferred embodiment of the present invention.

FIG. 5 is a schematic diagram illustrating a method for browsing an EPG according to the first preferred embodiment of the present invention.

FIG. 6 is a schematic diagram illustrating a method for browsing an EPG according to a second preferred embodiment of the present invention.

FIG. 7 is a schematic diagram illustrating a method for browsing an EPG according to the second preferred embodiment of the present invention.

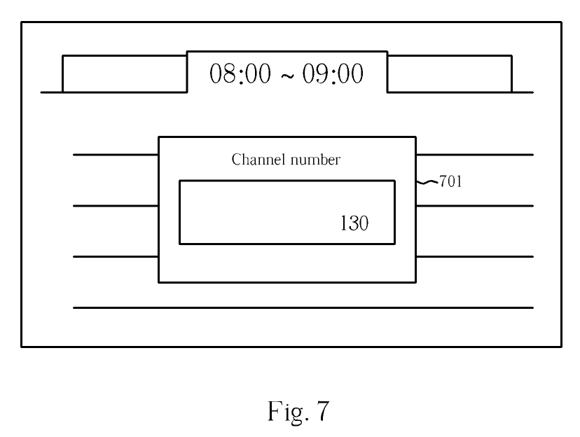

FIG. 8 is a schematic diagram illustrating a method for browsing an EPG according to the second preferred embodiment of the present invention.

FIG. 9 is a schematic diagram illustrating a method for browsing an EPG according to the second preferred embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

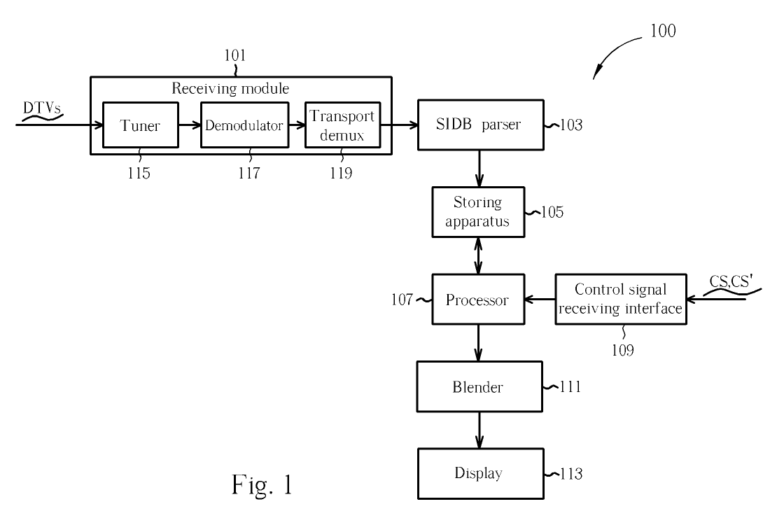

FIG. 1 is a digital television system 100 according to a preferred embodiment of the present invention. As shown in FIG. 1, the digital television system 100 comprises a receiving module 101, an SIDB (service information database) parser 103, a storing apparatus 105, a processor 107, a control signal receiving interface 109, a blender 111 and a display 113. The receiving module 101 comprises a tuner 115, a demodulator 117 and a transport demux 119. The receiving module 101 is used for receiving and processing a digital television signal DTVS. Since the receiving module 101 is well known by persons skilled in the art, detailed description is omitted for brevity. The SIDB parser 103 is used for extracting EPG data, and the storing device 105 is coupled to the SIDB parser 103 for storing the EPG from the SIDB parser 103. The processor 107, which is coupled to the storing device 105 and the blender 111, is used for accessing at least a part of EPG data to be displayed from the storing device 105 according to a control signal CS received by the control signal receiving interface 109. The blender 111 further processes the EPG data and other data to be displayed on the display 113 in order to transmit it to the display 113 for displaying.

The processor 107 receives a control signal CS indicating a specific channel from the control signal receiving interface 109, reads at least part of EPG data (in this embodiment, the at least part of EPG corresponds to the specific channel) from the storing device 105 and transmits the EPG data to the blender 111 for controlling the display 113 to display the EPG data. The control signal CS is from a remote control device in this embodiment. Also, the display 113 shows a dialogue window in response to a control signal CS′ of the remote control device, and the dialogue window shows the channel number information according to the control signal CS′. In this case, the control signal CS′ can be regarded as a dialogue control signal.

The pattern of the dialogue can be stored in the storing device 105, and the processor can read the dialogue from the storing device 105 according to the control signal CS′. The control signals CS and CS′ can be the same signal or independent signals.

The operation of the digital television system of FIG. 1 is described as below. It should be noted that the following description and figures are only examples and are not meant to limit the scope of the present invention.

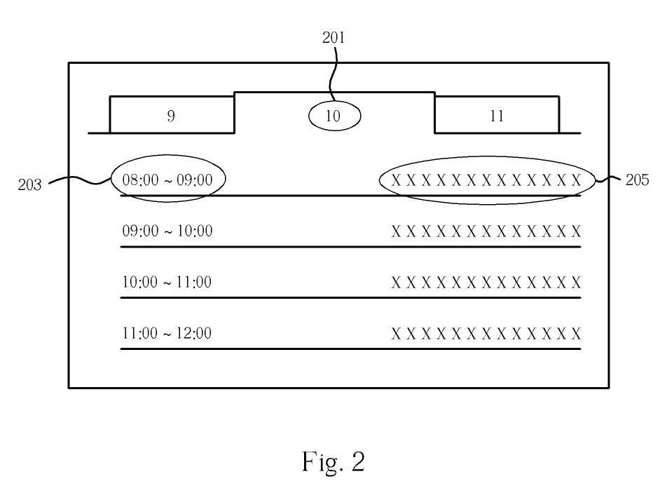

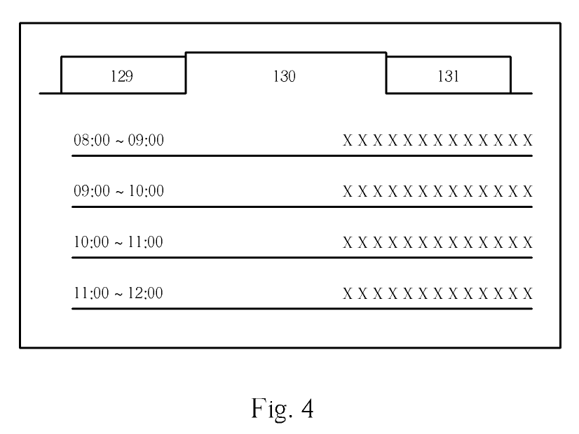

FIG. 2˜FIG. 4 are schematic diagrams illustrating a method for browsing an EPG according to a first preferred embodiment of the present invention, which are presented in channel arrangement and correspond to the digital television system 100 shown in FIG. 1. Conventionally, a user uses a control device such as a remote control device to control the digital television system 100, and the control signal receiving interface 109 receives the control signal and transmits it to the processor 107 after the user utilizes the control device to output a control signal of “browsing EPG”. In this embodiment, the display 103 displays the EPG data in accordance with an order of channel number or a lineup. The processor 107 reads corresponding EPG data from the storing apparatus 105 according to the control signal and sends the EPG data to the blender 111 for controlling the display 113 to display the EPG data.

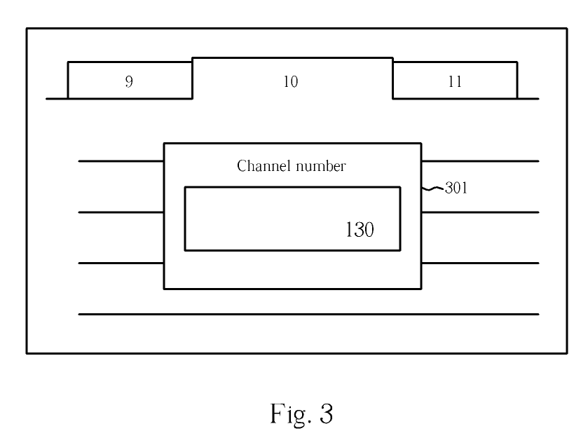

As shown in FIG. 3, the EPG data is classified according to channel 201 and comprises the program information 205 of channel and corresponding data information 203. The display 113 will display a dialogue window 301 if the user uses the control device to input a control signal CS′, such that the user can indicate a specific channel through the dialogue window 301 and the control device. The processor 107 reads the EPG data corresponding to the specific channel 130 and transmits it to the blender 111 after the user utilizes a control device to input a specific channel number 130 (that is, generating a control signal CS to the processor 107). After that, the blender 113 controls the display 113 to display the EPG data of the channel 130, as shown in FIG. 4. In this embodiment, the control signal CS includes a channel number information corresponding to a combination of numbers 0-9, and can further comprise a confirm information for confirming the channel number information is inputted. The confirm information can be generated from the control device or a timer. The processor can further control the display 113 to display an error message if the channel number information is wrong (for example, the inputted number does not exist). Additionally, the user can further utilize the control device to transmit a close signal to the processor for closing the dialogue window 301.

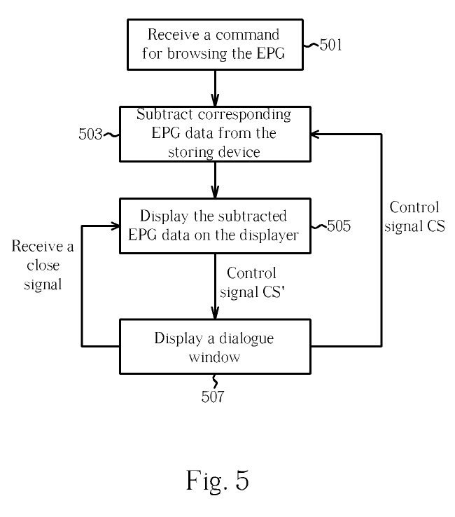

FIG. 5 is a schematic diagram illustrating a method for browsing an EPG according to a first preferred embodiment of the present invention, the method comprising:

Step 501: Receive a command for browsing the EPG.

Step 503: Extract corresponding EPG data from the storing device.

Step 505: Display the extracted EPG data on the display. Also, enter step 507 while the processor receives a control signal CS′, which is from the remote control device in one embodiment, for displaying a dialogue window.

Step 507: Display a dialogue window.

In step 507, the dialogue window is closed and goes back to step 505 if a close signal is received. Otherwise, step 507 goes to step 503 to extract corresponding EPG data from the storing device and goes to step 505 to display the extracted EPG data on the display if a particular channel number information is received (that is, the control signal CS).

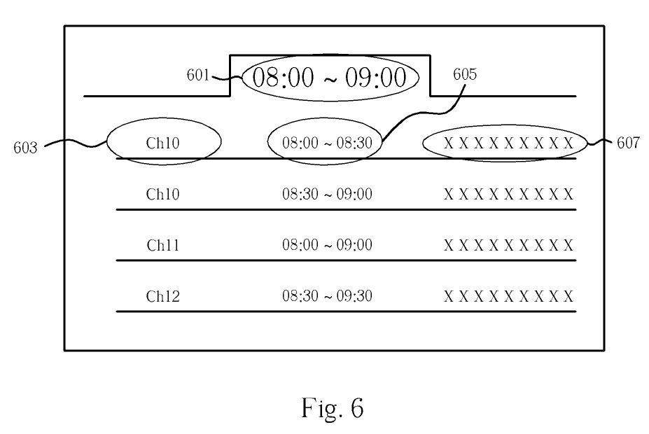

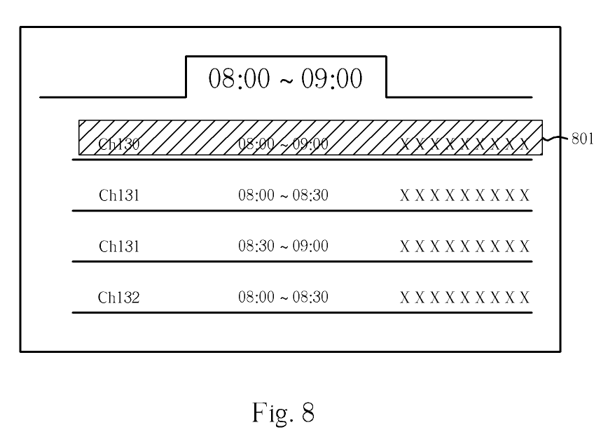

FIG. 6˜FIG. 8 are schematic diagrams illustrating a method for browsing an EPG according to a second preferred embodiment of the present invention, where the EPG is presented in a time arrangement format and corresponds to the digital television system 100 shown in FIG. 1. As shown in FIG. 6, the preferred embodiment is arranged according to time information 601, and displays the program information 607 corresponding to the specific channel information 603 and time information 605.

The display 113 will display a dialogue window 701 (or a dialogue) if the user uses the control device to input a control signal CS′ to the processor 107, such that the user can indicate a specific channel through the dialogue window 701 and the control device. After the user utilizes a control device to input a specific channel number 130 (that is, generating a control signal CS to the processor 107), the processor 105 controls the display 113 to display the EPG data having program information of the specific channel and highlights the program information corresponding to the specific channel, as shown in FIG. 8.

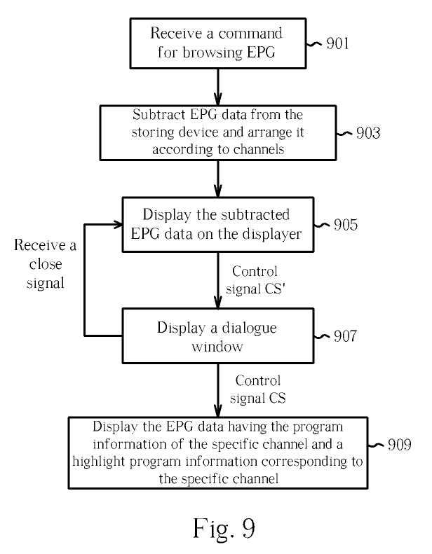

FIG. 9 is a schematic diagram illustrating a method for browsing an EPG according to a second preferred embodiment of the present invention, comprising:

Step 901: Receive a command for browsing the EPG.

Step 903: Extract EPG data corresponding to specific time and arrange it according to channels from the storing device.

Step 905: Display the extracted EPG data on the display. Also, enter step 907 while the processor receives a control signal CS′.

Step 907: Display an dialogue window. Enter step 909 if a processor receives a control signal CS.

Step 909: Display the EPG data having the program information of the specific channel and highlighting the program information corresponding to the specific channel.

According to the above-mentioned system and method, an user can get desired program data from the EPG rapidly and effectively and does not need to browse it step by step. It should be noted that, although the two preferred embodiments utilize channel arrangement and time arrangement as examples, this is not meant to limit the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A digital television system, comprising:
a receiving module, for receiving a television signal;
a parser, coupled to the receiving module, for extracting EPG (ELECTRONIC PROGRAM GUIDE) data of the television signal;
a storing device, coupled to the parser, for storing the EPG data;
a control signal receiving interface, for receiving a control signal from a remote control device;
a processor, coupled to the storing device and the control signal receiving interface, for accessing at least a part of the EPG data according to the control signal;
a display;
a blender, coupled to the processor and the display, for displaying the EPG data outputted from the processor on the display;
wherein the control signal comprises a channel number information.

2. The digital television system of claim 1, wherein the receiving module comprises: a tuner, a demodulator, and a transport demux.

3. The digital television system of claim 1, wherein the display displays the EPG data in accordance with an order of channel number or a lineup.

4. The digital television system of claim 1, wherein the display shows a dialogue window in response to a dialogue control signal of the remote control device, and the dialogue window shows the channel number information according to the control signal.

5. The digital television system of claim 4, wherein the display displays an error message if the processor determines the channel number information incorrect.

6. The digital television system of claim 4, wherein the display stops showing the dialogue window in response to a close signal generated by the remote control device.

7. A digital television system, comprising:
a receiving module for receiving a television signal;
a parser, coupled to the receiving module, for extracting EPG (ELECTRONIC PROGRAM GUIDE) data of the digital television signal;
a storing device, coupled to the parser, for storing the EPG data;
a control signal receiving interface for receiving a control signal from a remote control device, the control signal indicating a channel number;
a processor, coupled to the storing device and the control signal receiving interface, for reading the EPG data according to the control signal and highlighting the EPG data corresponding to the channel number; and
a blender, coupled to the processor and the display, for receiving the EPG data outputted from the processor and displaying it on the display.
